(19) United States
(12) Patent Application Publication
(10) Pub. No.: US 2010/0306096 A1
(43) Pub. Date: Dec. 2, 2010

(54) Cross-Border Trading System using existing market structures

(76) Inventor: William Edward Gorman, Sparks, MD (US)

Correspondence Address: WILLIAM EDWARD GORMAN, 14 ENGLISH RUN CIRCLE, SPARKS, MD, 21152, US

(21) Appl. No.: 12/567,727

(22) Filed: Sep. 25, 2009

Related U.S. Application Data
(60) Provisional application No. 61/100,277, filed on Sep. 26, 2008.

(51) Int. Cl. G06Q 40/00

(52) U.S. Cl. 705/37

(57) ABSTRACT

I have invented a system which enables the cross-border trading and settlement of securities and financial instruments worldwide by linking markets and exchanges using a specifically devised computer network. My system frees the markets and exchanges of prevailing limitations imposed by the need to harmonize the automated systems, rules, procedures and practices of existing markets and exchanges to achieve this objective. At the same time, my system does not affect the sovereign status of any home market or exchange, leaving all its laws and mechanisms uncompromised. In all of its respects, my system is novel, unique, without particular precedent, and has long been desired. It will advance economic activity and make possible growth with profit in markets and exchanges worldwide.

### CROSS-REFERENCE TO RELATED APPLICATIONS

This application claims the benefit of U.S. Provisional Application No. 61/100,277 filed on Sep. 26, 2008 entitled “Cross-Border Trading system using existing market structures” and is incorporated herein by reference.

### FEDERALLY SPONSORED RESEARCH

Not applicable

### SEQUENCE LISTING OR PROGRAM

Not applicable

### BACKGROUND OF THE INVENTION

1. Field

My invention, to be known as ‘SEERTrade®’, also to be current in usage without conflict between the terms, as ‘Gorman's Gambit’, has universal applicability to cross-border trading of securities and other financial instruments, linking securities markets using computers and communications technology, in all and every sense of that term, to include now and future technology, in a manner that enables all trading and settlement to be performed in the home market of a given security, under the rules, procedures and computer systems of that market, in a manner which has previously not been so inclusively, completely and practically conceived, attempted or invoked. It is new, original and unique, and surpasses any and all prior art in its relevance, advantage and applicability.

2. Background to my Invention

I have invented a system that links securities markets into a functioning cross-border trading and settlement network, where members of participating exchanges can trade and settle without compromising the automated systems of any participating exchange. With my system, orders meet, trade and are settled in the home market of the traded security or commodity using said market's rules procedures and prices

3. Prior Art

The cross-border trading of securities is experiencing exponential growth. It serves a vital need; but the present state of art that presumes to service its needs is complicated, inefficient, cost-deterrent and counter to full economic benefit.

The global management consulting firm, McKinsey reports: “With a few exceptions, it no longer makes sense to think in terms of national financial markets: they are increasingly being integrated into a single global one as cross-border holdings of financial assets and cross-border flows of capital grow . . . . Since 1995, cross-border capital flows have more than tripled, and they now total upward of $4 trillion annually, including foreign purchases of equity and debt securities . . . . These flows create stronger links among national markets and clearly show that despite the past decade's financial crises and the backlash against globalization, the world capital market continues to integrate and evolve.”

Cross-border trading is desired by a large number of investors. Companies with a regional or international presence generally want to spread their shareholder base across the regions they serve. The most common approach is to list on multiple exchanges or issue Global Depositary receipts, but this fragments the markets for their shares and results in multiple prices for what is essentially the same security. Other companies issue Initial Public Offerings (IPOs) in larger, more liquid markets, but this too results in fragmentation and draws trading away from their home markets.

As the art exists, cross-border trading to full financial advantage is deterred by substantial problems and inefficiencies. While Institutional Investors appear to have the infrastructure to make the investments they wish, the process is cumbrous, sluggish and short on efficiency, with each trade record needing to be touched 18 to 20 times between the initial order and its settlement. Retail Investors, by comparison, are hobbled and buffeted to a greater extent. It is easier for the latter to make a trade in London or New York, than do so, more desirably, in a country next door. Some such trades are impossible to initiate for lack of access to a broker who can make the trade. If, on the chance, a broker is identified, the retail investor is subjected to the fiscal embarrassment of paying two commissions, one to their local broker and one to the broker in the foreign country. The inability to make the necessary currency conversion further complicates the process.

Geography has been a forbidding factor. Most exchanges organize along national lines. Each country has its own markets and its own rules and procedures for operating those markets. Ten exchanges in the Middle East collectively have a Market Capitalization in excess of $1 Trillion. Yet it is easier and less expensive for an investor in those markets to trade in the US or UK than in a market in a neighboring country.

Over the last 30 years, many attempts were made to fuse markets or otherwise create cross-border trading and settlement mechanisms. This has been usually unsuccessful. Most did not achieve their goals and gave up, often after having spent substantial sums on development. Those that did have a circumscribed success, relied on harmonized rules and procedures and shared or common computer systems. The Nordic exchanges were successful in building a cross-border system but they had the advantage of a common owner OMX, (since absorbed by NASDAQ) that provided a common trading and settlement system.

In 1980, John Phelan, Chairman of the New York Stock Exchange (NYSE) proposed joining the New York, Tokyo and London exchanges into a 24-hour market. The idea was to pass an electronic order book between the exchanges in a continuous cycle. No technological underpinning was available, and it came to an end. My knowledge of this is through personal experience.

In 1988, the Hawaiian Development Council proposed creation of a market that bridged the time zone between the close of the New York market and the opening of the Tokyo market. One purpose was to create a 24-hour global market. Nothing came of it either. This is also a matter of personal experience.

In 1989-1991, the Federation of Stock Exchanges in the European Community (FSEEC) ran a project called PIPE (Price Information Project Europe), later dubbed Euroquote. PIPE was to be the foundation for a pan-European securities market. A vendor was selected to build a joint market data dissemination system, but then the process collapsed, mostly for political reasons and disbelief by some participant exchanges in the practicality of the venture. Here again, I have personal knowledge.

The 21 exchanges that comprise the Federation of Euro-Asian Stock Exchanges (FEAS http://www.feas.org) Participated with the Southeast European Cooperative Initiative (SECI) in mid-1998 launched a Cooperation Among Securities Markets in Southeast Europe project (online) http://www.secinet.info/?BIsDoc=I&docID=79 [Accessed 25 Sep. 2008]. The project postulated a Decentralized Trading Platform (DTP) as a vehicle for cross-border trading. It was faulted by a requirement for harmonization of rules, procedures and a common trading platform, and that was its end.

In September 2000 the Amsterdam, Brussels and Paris stock exchanges merged to form Euronext http://www.euronext.com/. Later the London International Financial Futures and Options Exchange (LIFFE) and the Portuguese stock exchange were absorbed. Euronext aimed at being a Europe-wide market. To participate, Euronext members had to harmonize their rules and procedures and adopt the Paris Bourse's electronic trading system.

In 2000-2001, the Amman, Bahrain and Dubai Amman exchanges contemplated creating a Regional TMT Board to trade technology, media and telecommunications stocks. Despite a significant investment in consultants, computers, and an automated trading system, the project failed. In effect, it was flawed in postulating the creation of yet another exchange without delivering any real benefit to its sponsors, the existing exchanges.

In mid-2001, the Union of Arab Stock Exchanges Secretary-General proposed an “Arab Stock Exchange” and an “Arab Clear” settlement system. The Arab Financial Markets Network http://www.ameinfo.com/news/Company_News/A/alshabaCa/ [Accessed 14 Sep. 2008] was created to assume this task. The goal was to enable region-wide trading of the most active and liquid securities. This was self-defeating, as the exchanges were putting their own survival at risk by funding the new exchange with their prime issues. The project came to an end.

In 2001, three exchanges in the African Stock Exchanges Association (ASEA), agreed an outline on integrating their markets. To date, little has been accomplished, the key problem being the harmonizing of rules, procedures and computer systems.

More recently, some parties have patented, or attempted to patent, various processes in support of cross-border trading.

U.S. Patent Application No. 2002/0087454 from Calo, Bea et al shows a global trading system that attempts to cut across international boundaries. This application is deficient in that two brokers (dubbed affiliates in the PA) are needed to execute a single trade. This raises the cost, and complicates issues of responsibility and risk. A Global Hub is also required. This is an expensive feature to maintain and operate and a pointed focus of failure. The system uses a network of Custodians and Sub-custodians to manage settlement, and a set of retail, settlement and liquidity banks beyond those normally needed for settlement. This may be acceptable to institutional investors who employ custodians, but is an inadequate and unsuitable approach for retail investors.

U.S. Patent Application No. 2002/0032642 from Graciela Chichilnisky describes an Internet based virtual exchange. It states that it is an invention for cross-border trading, but it does not actually perform any trading. It is primarily a settlement database. It requires creation and maintenance of a Global Hub. It also requires all of an investor's representatives (e.g. Asset Managers, custodians, banks, etc.) to link to the Global Hub. This is a manual process adding another layer of cost and complexity for retail investors. It also records beneficial ownership details at the broker or custodian level rather than in the Register.

In 2000, the Global Equity Market Initiative (GEM) was launched. http://www.businessweek.com/bwdaily/dnflash/aug2000/nf2000087_{—}774.htm [Accessed 22 Sep. 2008] Eight exchanges; New York, Toronto, Tokyo, Hong Kong, Australia, Mexico, Sao Paulo, and Euronext (Paris, Brussels, Luxembourg) representing 60% of the world's traded market capitalization sought to use GEM as a global marketplace. Around 10% of the participating exchanges' securities would trade on GEM. The remainder would trade as before. Unfortunately, a loss of 10% of an exchange's business would cause a fatality, leaving the rest of its market essentially uncovered. Some markets stood to lose more than ten percent.

In September 2002, Malta proposed that the Mediterranean and Middle East stock exchanges together establish a Mediterranean Stock Exchange named BorzaMed. http://www.borzamalta.com.mt/annualreports/AR2002.pdf [Accessed 22 Sep. 2008]. A key objective was to establish cross-border trading between these exchanges in these regions. Nothing came of it.

In April 2004, the European Union (EU), adopted the Markets in Financial Instruments Directive (MiFID). This EU law is aimed at establishing a single market in http://ec.europa.eu/internal_market/securities/isd/index_en.htm [Accessed 22 Sep. 2008] financial services across the European Economic Area. Firms covered by MiFID are to be authorized and regulated in their home state and provide services to customers in other EU member states while remaining regulated by their home authority. MiFID will cause a gradual harmonization of rules and procedures across the European Economic Area. The drawback here is that the process will take years to implement and is inhospitable to wider geographical replication and has fragmentation as a standard feature.

A few years ago, the Stock Exchange of Mauritius proposed I-Net, an Internet-based cross-border trading system. Their plan uses two brokers (and two commissions) on each trade. It requires brokerage firms in each exchange to maintain a contractual relationship with a firm in each of the other exchanges. Thus, if ten exchanges are in the trading network, each brokerage firm must establish a contractual relationship with nine foreign firms. This is a costly exercise with attendant counterparty (credit) and operational risks.

In April 2007, NYSE http://www.nyse.com/ and Euronext merged to form NYSE Euronext. The new firm's CEO stated that it intends to form the world's first global stock market, with continuous trading of stocks and derivatives over a 21-hour trading day. Subsequently NASDAQ absorbed OMX (owner of several exchanges)

NASDAQ OMX and NYSE Euronext are two examples of exchanges whose business models target cross-border trading. However, they do not want and cannot accommodate entry-level companies. Both organizations are looking at only the top tier of globally traded securities. Second and third tier securities are more ignored and unserviced.

Seven exchanges in the Caribbean have proposed joining together into a joint cross-border trading and settlement system. They are however emphasizing the need for harmonized legislation and harmonized rules.

None of the attempts to link markets worldwide have succeeded except those that used common systems and harmonized rules and procedures. This is an enormous undertaking and grows more complicated as the number of exchanges increases. It requires agreement between the exchanges and regulatory approval. The systems must be built, tested and installed. Cost-sharing arrangements are needed to help the smaller exchanges.

The requirement for common systems and procedures can impede entrepreneurship and development of new approaches by the exchanges. The experience of the several organizations cannot be broadcast to other countries due to respective sovereign considerations, regulatory constraints, existing legacy systems and cost commitments.

### Companies—Prior Art

The top tier of securities in most markets has a regional or global presence. These securities are the lifeblood of their respective markets. Many can be traded only in their home market given the associated difficulties. These companies seek to expand their shareholder base regionally by listing on multiple exchanges, issuing Global Depository Receipts (GDR), or creating new securities through a relocated Initial Public Offering (IPO). In the result, the market gets fragmented, multiple prices arise for the same security, price discovery becomes inefficient and ownership records are in confusion.

In relation to multiple listings, April 2003, a World Bank study concluded, “ . . . internationalization reduces the liquidity of domestic markets through two channels. First, the trading of international firms migrates from domestic to international markets and the reduction in domestic liquidity of international firms has negative spillover effects on domestic firm liquidity. Second, there is trade diversion within domestic markets as liquidity shifts out of domestic firms and into international firms.”http://siteresources.worldbank.org/DEC/Resources/MigrationSpilloversandTradeDiversion.pdf [Accessed 25 Sep. 2008]

### Investors—Prior Art

Today most cross-border trading is conducted by Institutional Investors. It is difficult for most Retail Investors to trade outside their home countries.

Regional and internationally minded investors want to invest globally so as to earn higher returns and diversify their portfolios. Institutional Investors have the means and infrastructure to trade across borders. Retail investors cannot, except at high cost. For example, US investors have expressed interest in investing in Iraq's markets, but few investors can do so. From the investor's perspective, finding, evaluating and investing in attractive enterprises in remote markets is expensive and fraught with risk.

### Brokers—Prior Art

Many brokers have opted to become members on multiple neighboring exchanges. This is a complex and costly undertaking, especially as each country has its own broker licensing rules, procedures and costs.

### Exchanges—Prior Art

Geography has divided most of the world's securities markets into fragments along national boundaries. Many of these markets are too small to be globally active. However, they do have securities that are of regional and global interest.

Small stock exchanges become increasingly difficult to sustain. They lack liquidity, their borders limit trading activity, and they are subject to loss of prime listings to larger markets. Local markets suffer and their viability is threatened when they lose their prime offerings to other markets. This has negative effects on both the security and the home market of that security.

### Regulators—Prior Art

A country's regulatory authority may be reluctant to permit the listing of a company's securities on multiple markets because of the potential negative impact on their ability to properly monitor the market. Another difficulty is identifying foreign investors with large holdings in shares under the regulator's scrutiny.

Regulators are concerned that joining markets introduces systemic risk, and seek harmonization to address their concerns. Systemic risk is the inability of one institution to meet its settlement obligations when due, causing other institutions to fail to meet their own obligations when those fall due. Settlement is a zero sum game. Unless otherwise guaranteed, a trade that fails to settle introduces systemic risk to the market.

Depository Trust and Clearing Corporation (DTCC), knows the broker or custodian, and except in the case of Institutional Investors it does not know the identity of the beneficial owner. Depositories have widely varying systems for maintaining ownership records. Many foreign clearing houses and depositories, in accordance with local law, hold securities in beneficial owner name. One clearing house cannot extend direct services due to sovereign regulations and restrictions on the holding of national assets such as securities.

### Countries—Prior Art

Ten Middle-Eastern countries host exchanges with a collective market capitalization in excess of $1 Trillion. Yet it is often easier and less expensive for an investor in a Middle Eastern country to trade in the US or UK markets than in a neighboring market.

At the national level, this has profoundly negative long-term implications for job creation, tax revenue, and economic growth. Since the vast majority of jobs in mature economies are generated by small businesses, these companies also contribute most of the tax revenue allocated for social programs and infrastructure development.

Many groups have tried to build cross-border trading systems but have avoided joining existing systems, as it was widely believed to be too complicated and necessitating extensive changes to existing software. It is generally believed that the disparate, heterogeneous trading and settlement systems could not be joined without harmonizing the rules, procedures and software. Exchanges that have successfully joined together have done so using common systems and software and harmonized rules and procedures.

In a working paper “World Stock Exchanges are integrating/consolidating/merging: What can be done by Arab Exchanges” the Cairo and Alexandria Stock Exchanges claimed that, “For Arab stock exchanges to have fruitful integration/alliances discussion, they should first start working on having similar rules and regulations, since this area will impose the greatest impediment to any integration/alliances exercise. http://download.egyptse.com/download/research_papers/world %20stock%20exchanges.pdf [Accessed 25 Sep. 2008]

I recognize that a number of attempts have been made to create a regional trading network in the Middle East and elsewhere. These efforts had a number of fatal flaws. First and foremost, they required participating exchanges to make major, and sometimes worrying changes to their systems and procedures. In other cases common computer systems were required, or totally new exchanges or systems were created.

### Current Practice

FIG. 1 illustrates the typical manner in which retail cross-border trades are currently processed.
1. The investor gives purchase/sale order to a broker/dealer (hereinafter referred to as Originating Broker).
2. The Originating Broker sends the investor's order to a broker/dealer (hereinafter referred to as Executing Broker) in the market in which the desired security is traded, and with which the Originating Broker has a business relationship. This is typically done via telephone, fax, email or other.
3. The Executing Broker enters the order into the exchange's Automated Trading System (ATS).
4. The automated trading system stores the order into its electronic order book. When a trade is executed, the ATS send a Trade Confirmation to the Executing Broker.
5. The Executing Broker then sends, via telephone, fax, email or other, the Trade Confirmation to the Originating Broker.
6. The Originating Broker then gives the investor a Trade Confirmation showing the details of the trade, the currency conversion rate used for the trade, and associated commissions.
7. At the end of the trading day, the executing exchange sends a Trade Report to the Depository or other settlement agency, of the trades that the Executing Broker made that day.
8. The depository sends to the Settlement Bank a pay/collect report detailing the net amount of funds that each brokerage firm pays/collects for that day's settlement.
9. The depository sends the Executing Broker a Settlement Statement of the trades the broker made that day with a net total to pay or collect.
10. The Executing Broker sends a Settlement Advice detailing the amount due or owed via telephone, fax, email or other to the Originating Broker.
11. The Originating Broker sends a Settlement Statement to the client. In the case of a buy transaction, the investor pays the Originating Broker in the investor's local currency. Paying or collecting against a trade tends to be an ad hoc practice. The Executing Broker is responsible for money settlement regardless of whether or not the broker has collected the funds from the foreign broker.
12. The client pays or collects to/from the Originating Broker in accordance with ordinary practice.
13. The Originating Broker deposits or withdraws to/from a local bank or other foreign exchange facility, funds in local currency equivalent to the amount due in the currency in which the trade was executed.
14. The local bank or other foreign exchange facility transfers those funds to the Executing Broker's account in that broker's bank or other foreign exchange facility.
15. The Executing Broker arranges to deposit or withdraw funds from the local bank or foreign exchange facility based on net amounts due for that broker's trades.
16. On Settlement Day, the Executing Broker withdraws or deposits the net amount due to, or from the Settlement Bank.
17. On Settlement Day at a predetermined time, the Settlement Bank verifies that all funds due have been collected. Upon verification, it transfers the funds from the net buyer accounts to the net seller accounts. It then advises the depository that the money settlement has been completed.
18. The depository then settles the share side.

Note: the broker/dealer in the investor's home market must have a relationship with a broker/dealer in the market in which the desired security is traded. Otherwise, the investor's broker/dealer must process the trade request through a firm that has such a relationship.

### ADVANTAGES

My invention is superior because all trading and settlement is done in the country of issue using that country's rules, procedures and computer systems, and no changes to the local market's computer systems are needed.

My invention fulfills a long-felt but unsolved need, and is conceived, created, articulated and graphically demonstrated to improve and strengthen the existing markets, applying present and future technology, and make them more accessible and better able to serve the investment community. This has been unobvious to Prior Art, which has been enfeebled by the absence of the original thinking or novelty that informs SEERTrade® or Gorman's Gambit in successfully responding to the prevailing challenges. No attempt in Prior Art has conceptualized the method, manner and mechanism in which real and meaningful cross-border trading in securities can be realized to full-blown global economic advantage as my invention posits and envisions.

On the broadest and most comprehensive scale, and without fetter or limitation, SEERTrade® or Gorman's Gambit works in the ways highlighted hereunder.
Enables a more direct path. It is a cross-border trading and settlement process that uses the existing and evolving market infrastructure in each market.
Eliminates the manual processing that occurs when an Executing Broker reports a trade to the Originating broker, and does so without entailing multiple brokers on a single trade and without charging multiple commissions.
Provides a mechanism for linking the exchanges into a secure cross-border trading platform without requiring common rules, procedures or computer systems.
Creates a cross-border system, in which identical securities can be issued, traded and settled at the same price across the markets after foreign exchange conversion.
Establishes a platform where investors can buy and sell shares in participating markets without restriction.
Creates a trading environment that enables investors to fully participate on an equal basis.
Enables qualified brokers to participate in all markets on an equal basis and with the same rights and responsibilities as each market's local brokerage firms.
Allows the constituent markets to develop their own innovations without necessitating all participating markets to adopt the same changes.
Provides a gateway to international access with secure support for proper regulatory oversight.
Broadens and enhances the marketplace for those securities having a regional or international presence, without necessitating listing on multiple exchanges or creation of Depository Receipts.
Eliminates market fragmentation.
Automates the flow of trading and settlement across borders.
Promotes improved market liquidity and provides access to a larger investor base.
Enables expansion of a listed company's shareholder base and provides improved and more accurate shareholder records.
Reduces cross-border trading costs.
Addresses regulatory requirements including anti-money laundering (AML) issues.

### SUMMARY OF MY INVENTION

My invention, known and styled as SEERTrade® or Gorman's Gambit, solves the deficiencies of, and prevails over the prior art, by a computerized linkage system between securities markets in the manner herein illustrated, explicated and described, and which system has not at any earlier time come within the compass of any thought, idea, attempt, concept and speculation to create a cross-border trading system in securities and financial instruments in the manner and method uniquely and originally conceived by my system, which, in no way and neither by artifice, will compromise, abridge, adapt, alter, suppress, circumvent or vitiate the sovereign status, rules, regulatory practices and conventions of existing securities markets and exchanges anywhere and everywhere, using present and future technology to the lasting benefit, advancement, advantage and greater good of human enterprise.

SEERTrade® or Gorman's Gambit extends the automated trading and settlement services of each participating market to authorized members of each and every other participating market. It enables a customer to purchase or sell a stock or other security that is traded in another country or market through their local broker.

All transactions are executed and settled in the home market of the security using that market's rules, procedures and computer systems. Brokers can view the participating foreign markets and enter orders and other trade-related transactions to those markets from their ‘SEER Broker Workstations’ or their firm's Order Management System (OMS). These transactions are routed through the ‘SEER Market Network’ to the home exchange of the security and entered into that market's ATS on an equal basis with that market's brokers.

Therefore, my invention allows securities markets and exchanges, and their participants, to extend their offering to include foreign equities and other financial instruments. It makes use of client-server utilities to streamline the whole process of financial transaction as well as automate the settlement process.

Identical securities can be issued and traded without hindrance or restraint at the same price across any or all markets allowing for standard foreign exchange adjustments, facilitating the buying and selling of foreign securities without restriction

### HOW SEERTrade® OR GORMAN'S GAMBIT WORKS

A SEER Message Server (or processing mechanism) is installed at each participating marketplace.

It is coupled with that market's Automated Trading System (ATS).

It is coupled with that market's electronic settlement system computers.

It is linked to a local Foreign Exchange facility.

It is connected to a plurality of SEER Broker Workstations or alternatively, linked directly to the Order Management System (OMS) of those brokers who maintain such systems.

It is joined to the SEER Network (or overall communications mechanism), and through that network to each of the markets in the network.

The SEER Message Server collects real-time market information (i.e. bids, offers and last sale prices) from each participating market's ATS. It selects the needed information and distributes it to the SEER Message Server at every participating exchange and to market data vendors via the SEER Network.

The receiving server stores the data in a local database and delivers it to the broker workstations and the broker Order Management Systems (OMS) to which it is connected.

Each server collects foreign exchange information and makes it available to the broker workstations and the broker Order Management systems to which it is connected.

Brokers view the Order Book (including foreign exchange quotations and advisories) and enter orders.

Each SEER Message Server receives buy and sell orders and other trade-related transactions from brokers in its local market and routes those transactions to the Automated Trading System (ATS) in the home market (via that market's server) of the security defined in the transaction.

The receiving server enters the order into the local market in a format recognized by the receiving exchange.

The home market ATS performs the actual execution.

The SEER Message Server receives trade Confirmations and other messages from the ATS and routes them to the order originator, and receives and distributes Settlement related reports. It is the gateway interface between broker workstations and broker OMS, and each of the foreign Depositories.

It interfaces with foreign exchange facilities and banks for the exchange of real-time and static foreign exchange quotes, executions, bank guarantees, and other transactions and information related to foreign exchange.

Brokers in participating exchanges would see the market in all participating exchanges. A broker in one exchange could submit a bid or offer for a security listed and traded on another exchange. When that order is executed by the listing exchange, the network would report the transaction to all parties involved in the transaction. The buying broker and selling broker would each settle with the home depository of the security,

In the preferred embodiment of my invention, order information is transmitted using web-based technology or using a computer-to-computer interface (e.g., a direct link to a user's order capture system). For example, the order or other transactional information transmitted by the broker is formatted to the FIX (Financial Information Exchange-http://www.fixprotocol.org), or another standard electronic format, and then is transmitted via a communications network and stored on local servers to which each broker has access.

By increasing investor access to developing markets, my invention, the SEERTrade® or Gorman's Gambit will preserve the integrity of national stock exchanges and reduce the need for multiple listing of shares by large local companies. Frontier stock exchanges can give their listed companies a global presence. Deploying services and solutions that help smaller companies list and trade on local stock exchanges helps local stock exchanges present their listed companies to a global network of investors thereby creating a unique value proposition.

### BRIEF DESCRIPTION OF THE DRAWINGS

For a detailed description of the preferred embodiments of my invention, reference will now be made to the accompanying drawings in which:

FIG. 1 illustrates typical cross-border trade processing today.

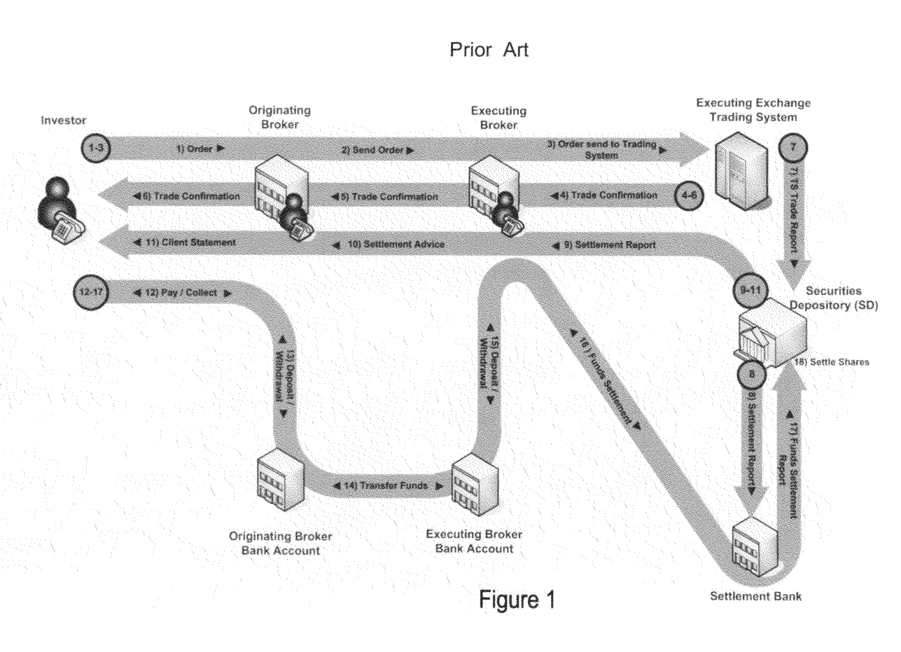

FIG. 2 is a global diagram broadly illustrating a communications network joining securities markets from four countries into a shared trading and settlement platform.

FIG. 3 is a flow diagram of the key message types processed by my invention.

FIG. 4 is a block diagram illustrating the key modules and interfaces of an exemplary SEER Message Server constructed according to the preferred embodiment.

FIG. 5 is a flow chart which shows processing by SEER Broker Workstations.

FIG. 6 is a diagram illustrating the flow of market data collection, filtration, distribution and display.

FIG. 7 is a diagram illustrating foreign exchange quotation flow according to the preferred embodiment.

FIG. 8 is a diagram illustrating the order placement and execution flow.

FIG. 9 is a flow diagram reporting settlement.

FIG. 10 is a diagram illustrating the flow of system control and administrative messages, and the exchange of supporting information between markets.

FIG. 11 is a sample screen shot illustrating market information in both local and foreign currencies.

### DRAWINGS

### Reference Numerals

100 Settlement Bank
200 Depository
300 Automated Trading System (ATS)
400 Broker Workstation
500 SEER Network
600 SEER Message Server
680 Interface Layer
681 Filtration Process
682 Transaction Logger
683 Financial Data Processor
684 Routing Processor
685 Report Processor
700 SEER Broker Workstation
800 Foreign Exchange Facility
900 SEER Administrative Workstation

### DETAILED DESCRIPTION OF THE PREFERRED EMBODIMENTS

The detailed description of the preferred embodiment provided below includes many details which demonstrate my invention. For example, many of the examples describe a hypothetical party in Abu Dhabi buying or selling a security in the Jordanian market.

However my invention is not so limited and is not limited to the United Arab Emirates or Jordan or any specific country or securities market. These designations are used merely to simplify the explanation of the preferred embodiment.

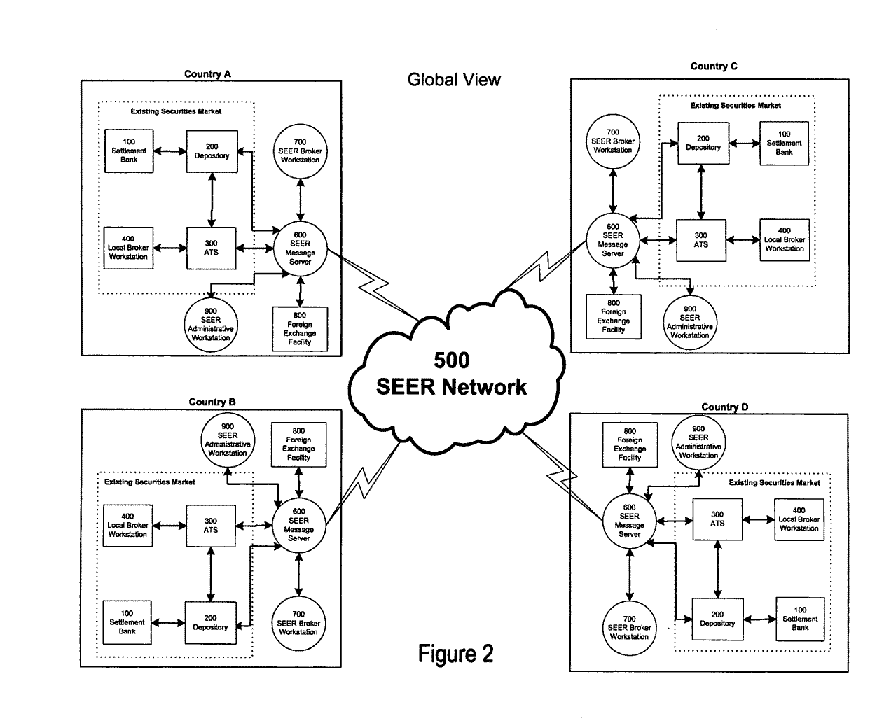

FIG. 2 is a diagram showing four securities markets in four countries linked together via the SEER Network. It illustrates the various entities associated with trading and settlement in a local market. These are an Automated Trading System (ATS) 300 and accompanying ATS workstations 400, an electronic settlement system, usually in the form of a Securities Depository 200, and a Settlement Bank or Banks 100. It further illustrates the SEERTrade® components that join the individual markets into a coordinated marketplace. These are SEER Message Server 600, SEER Broker Workstations 700, SEER Administrative Workstation 900, local bank or foreign exchange facility 800, and the SEER Network 500.

FIG. 2 illustrates how each market's ATS and electronic settlement system is interfaced with a local SEER Message Server. The SEER Network links these servers. This provides each participant in each market with access to the services of every other market in the network.

The SEER Message Server supports a set of SEER Broker Workstations 700, which provide the local market's brokers access to the foreign markets. Alternatively, brokers that have operational Order Management Systems (OMS), can link to the SEER Message Server via the FIX or other international financial market protocol.

FIG. 2 also illustrates the linking of a securities market's trading and settlement systems to the SEER Network. Neither the ATS nor the depository system is aware of external protocols and data formats. The two work independently from SEERTrade®, utilizing their own data format. It is the responsibility of the SEER Message Server to translate between its protocol and the internal formats and protocols employed by the participating markets.

The cross-border trading model of the preferred embodiment employs a private network independent of topology or implementation. The SEER Network supports one-to-many, point-to-point, and many-to-many communications. This enables a member of any market on the network to purchase or sell a stock or other financial instrument that is traded on any other market on the network.

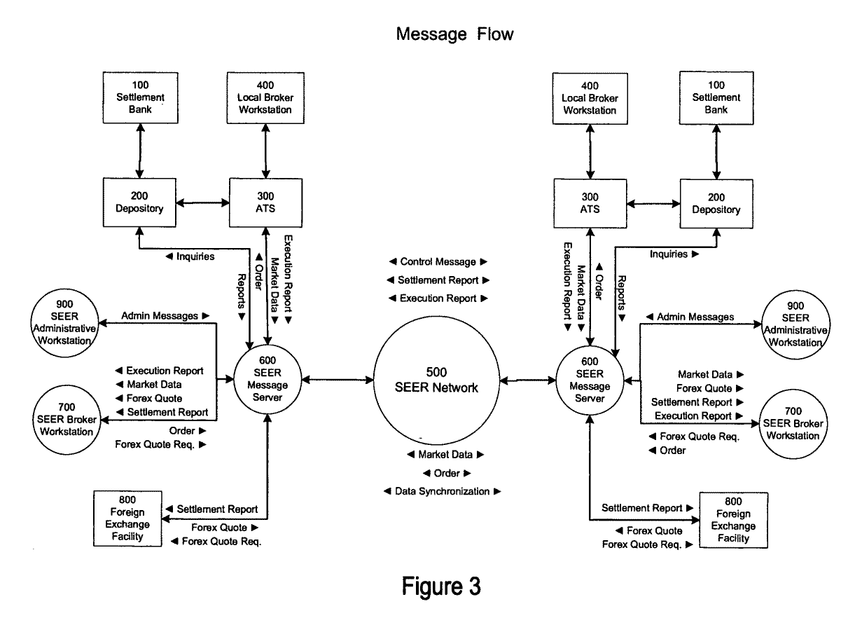

FIG. 3 is a flow diagram illustrating the primary message types and the direction in which the messages move between the component elements of SEERTrade®.

### SEER Message Server

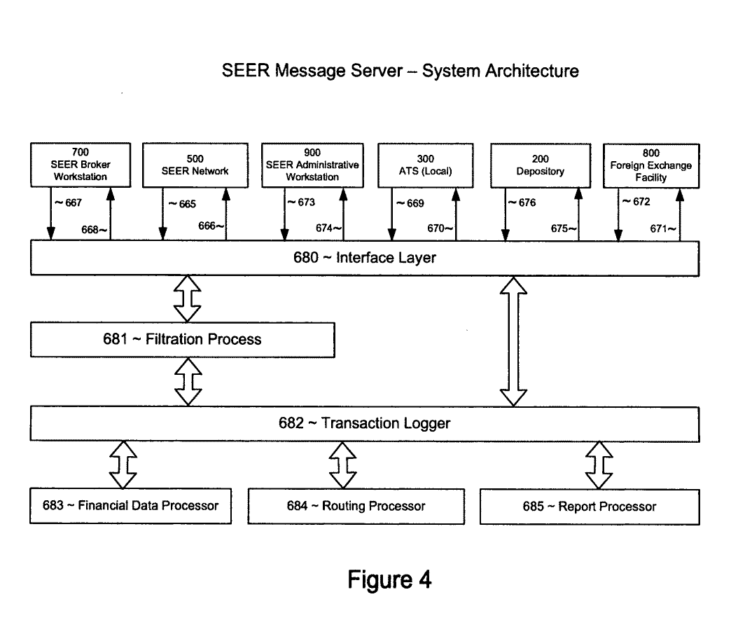

FIG. 4 is a block diagram of the SEER Message Server architecture which illustrates the server's primary component modules and disparate external entities with which it interfaces. In the preferred embodiment the SEER Message Server interfaces with six such entities. These are the local market's ATS 300, the local Depository 200, the local bank and foreign exchange facility 800, SEER Broker Workstations 700, SEER Administrative Workstations 900 and the SEER Network 500.

### Message Server Component Modules

The component modules include but are not limited to: an Interface Layer 680, a Filtration Process 681, a Transaction Logger 682, a Financial Data Processor 683, a Routing Processor 684, and a Report Processor 685.

The Interface Layer 680, provides a programmatic mechanism by which each of the disparate external entities seamlessly communicates with the message server. This enables each of the market participants to continuously innovate independently and without limitation.

The Filtration Process 681, selects or discards messages received by the server using the rules of the home market. Its primary function is to extract from the local market's real-time data the information relating to securities available and authorised for cross-border trading.

The Transaction Logger 682, logs all messages input to the server and output by the server to a database used for recovery, data analysis and debugging.

The Financial Data Processor 683, is responsible for managing and distributing internal market information such as exchange rates, bank guarantees, trading rules, market calendars, listed security information, broker registrations and local client account numbers.

The Routing Processor 684, determines, and distributes incoming messages to, the intended destinations.

The Report Processor 685, generates various reports on system performance using the Message Log and other internal logs. This is devised to provide ad hoc reporting capability.

### Local Server Functions

The local SEER Message Server collects on-line market data (bid, offer and last sale prices and volume information), on a real-time basis; administrative messages, and all other information referenced at 669, from the local ATS. It filters out information pertinent to those securities eligible for cross-border trading and discards the rest. It disseminates the remainder to all other participating markets.

The local server receives real-time and static foreign exchange quotes, bank guarantees and other information referenced at 672, related to foreign exchange, from the local bank or foreign exchange (FX) facility. The server routes this information to the local SEER Broker Workstations and local broker OMS. Update requests are also sent to the FX facility (671).

The local server receives bids and offers from the local SEER Broker Workstations and local broker OMS (667), and routes these to the market of the order (670).

The local server receives trade confirmations, cancellations and other reports from the local ATS and the local Depository, and routes these to the required destinations (668).

The local server receives trade confirmations, cancellations and other reports from remote ATSs and Depositories 676 via the SEER Network, and routes these to the appropriate local SEER Broker Workstations or broker OMS.

The local server receives from all other SEER Message Servers, market information referenced at 666, pertinent to those other markets, and passes this information to all local SEER Broker Workstations and broker OMSs.

The local server receives requests and directives from the local SEER Administrative Workstation and routes this traffic to the remote SEER Server for appropriate action (673 and 674),

Where necessary, the local server provides connectivity with simple terminal systems through basic terminal emulation software.

All communications are effected by the SEER Network, referenced at 665 and 666.

### Automated Trading System (ATS)

The local ATS receives from the SEER Message Server orders, as referenced at 670, and processes these transactions in accordance with local market practice. It reports to the server resulting trades or actions (669), which are then routed to the order originators. As detailed above, the local server collects local market data from the ATS and distributes it to all of the other markets in the SEER Network.

### Depository

The local Depository processes inquiries 675 from foreign SEER Broker Workstations and SEER Administrative Workstations, and delivers Settlement Reports 676 to the local SEER Message Server for onward routing.

### SEER Broker Workstations

The local workstations receive, store and display market and foreign exchange data from the SEER Message Server 668. As detailed above, these workstations are used to submit bids and offers (667) for foreign securities to the server for required market routing. In an alternative embodiment, a broker OMS would substitute for the workstations.

### Foreign Exchange

The local bank or foreign exchange facility receives inquiries from system users through the SEER Message Server (671). It then delivers real-time and static foreign exchange quotes, executions, bank guarantees and other transactions, to those users through the SEER Message Server (672).

### SEER Administrative Workstations

The purpose of the local Administrative Workstation is to configure, monitor and control the local SEER Message Server, and communicate control information between markets (674).

### SEER Broker Workstation Functionality

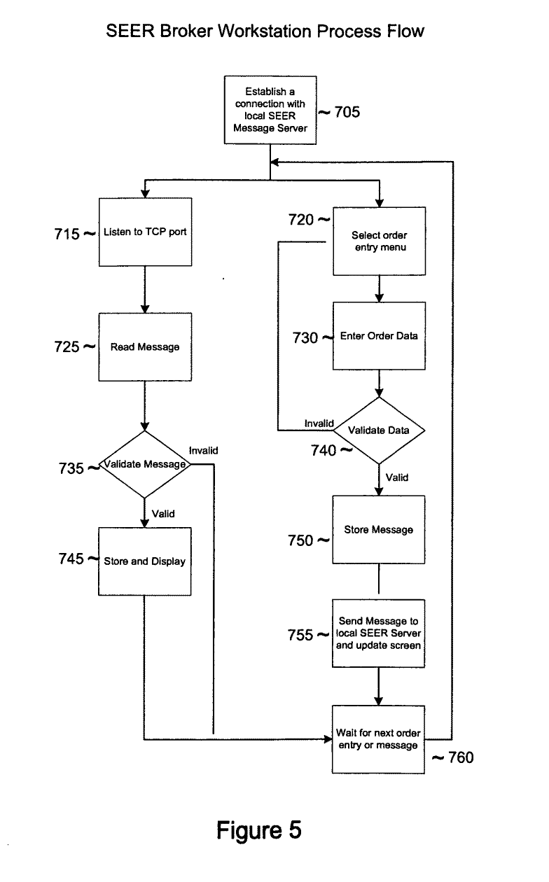

FIG. 5 is a flow chart of the key activities of the SEER Broker Workstation 700. The workstation is a standard PC and performs the basic functions of securities trading and settlement. As is the case with industry practice, the workstations are user configurable. In those cases where the ATS or Depository uses a simple terminal to access its computers, the workstation uses a standard terminal emulation program to perform this function.

In step 705, the workstation establishes a connection to the local SEER Message Server as part of the sign-on process. It then takes market data from the server, stores it in its local database and uses the data for display on the broker's workstation screens.

Step 715 illustrates the workstation listening at the communications port for messages from the local server. In step 725, the workstation reads the messages. These consist of market data (i.e. bids, offers and last sale prices), trade confirmations, settlement instructions, etc. from the other markets in the network. The workstation validates the messages in step 735, and if invalid rejects the message.

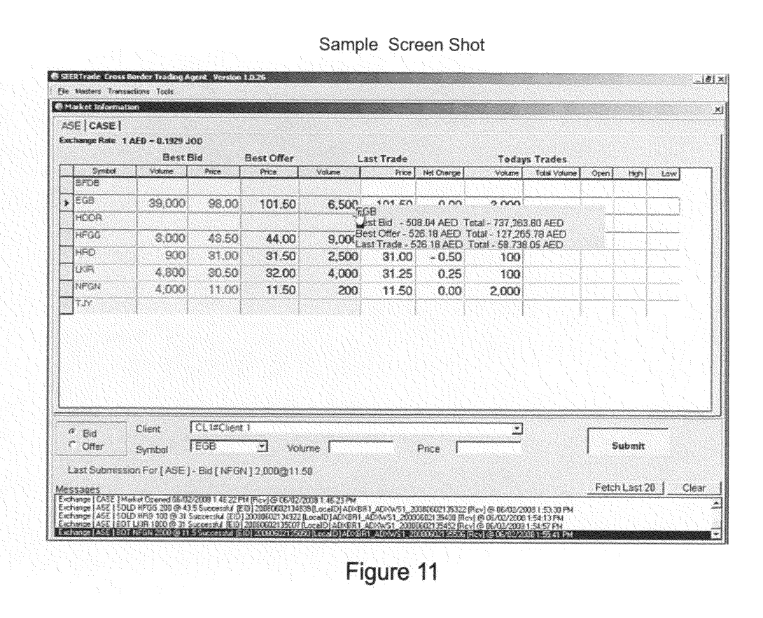

In step 745, the workstation stores the messages in its local database, and processes or displays them according to type (e.g. market prices, currency conversion rates, trade confirmations, administrative messages, etc.). An example display is illustrated in FIG. 11. The workstation then goes into ‘listener’ mode awaiting the next message or action by the workstation operator.

In step 720, the broker reviews the market and requests an order entry screen. In 730, the broker enters a bid or offer for a particular security. To facilitate this, the system provides the broker local currency quotations, on request.

In step 740 the order data are validated. In step 750, valid messages are stored in the workstation's local database. In step 755, the message is transmitted to the local SEER Message Server and displayed on the workstation screen.

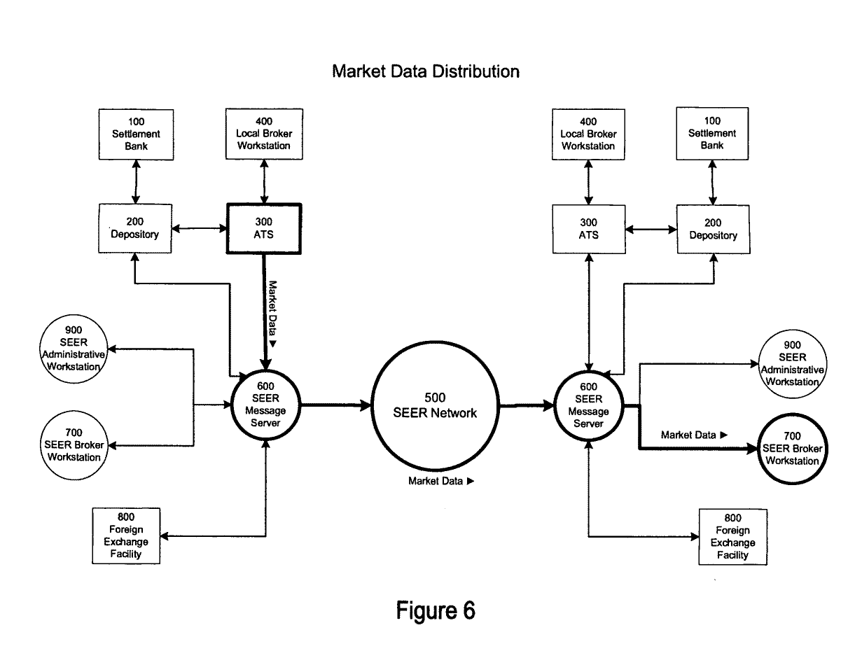

The system of FIG. 6 illustrates the gathering of market information from one market and its distribution to all of the other participating markets. The first step in the process is the generation of market data (bid, offer and last sale prices and volume information), by an exchange's ATS in response to market activity at the exchange. The local SEER Message Server collects, on an on-line, real-time basis, market data, administrative messages and all other data published by its host market. It validates and selects data applicable to cross-border trading in accordance with rules stored in its local database, and multicasts the data to every server on the SEER Network. The receiving server stores the data in its database and distributes it to every local SEER Broker Workstation and broker Order Management System (OMS). The broker workstation receives the market data from the server on a real-time basis, stores it and makes it available for display.

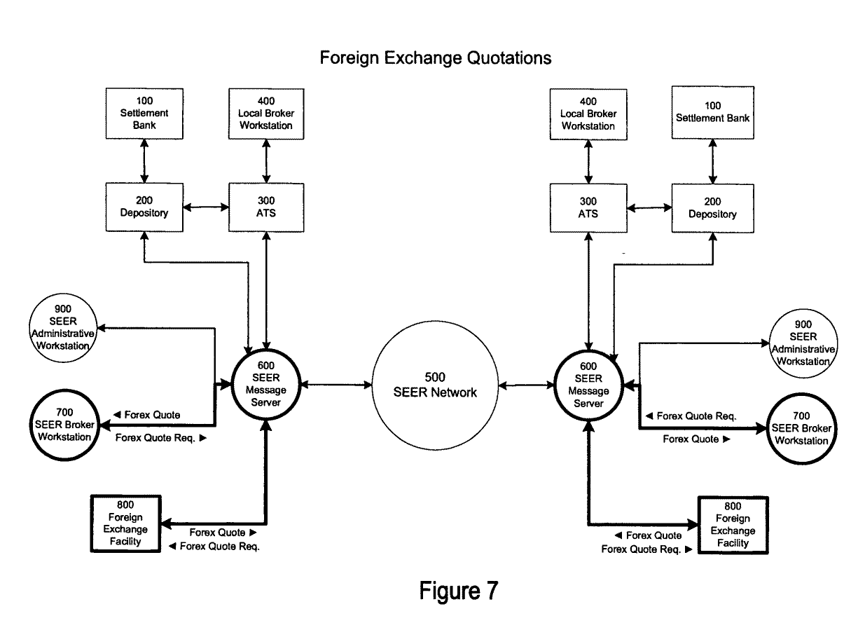

FIG. 7 relates to providing FX information for currency conversion processing. To support this, one or more local foreign exchange facilities interface with SEER Message Server's in each market. The servers retrieve this information in real time or on request, and deliver it to the broker workstations and OMSs. This information is then used by the workstations and OMSs to provide bid, offer and last sale prices in the local currency.

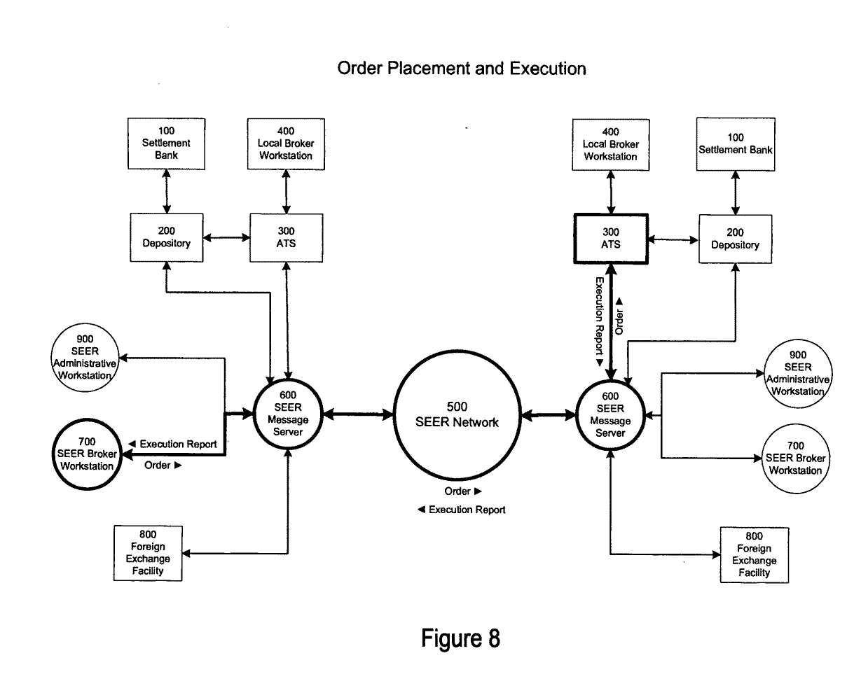

The system of FIG. 8 illustrates an authorized broker in a securities market in one country entering an order to purchase or sell a stock that is traded in another country. In the preferred embodiment, the broker enters an order at the SEER Broker Workstation. The local SEER Message Server receives the order and routes it to the message server in the home market of the security. The receiving server submits the order to that market's automated trading system. The order acknowledgement is returned to the originator via the same path. The ATS in the receiving market stores the order in its local electronic order book. Upon execution, the ATS sends a Trade Confirmation to each party. These confirmations are received by the local message server and reported to the originator of the trade. The same procedure is followed with those brokerage firms that have their own Order Management Systems (OMSs). This can be used for both listed and unlisted securities.

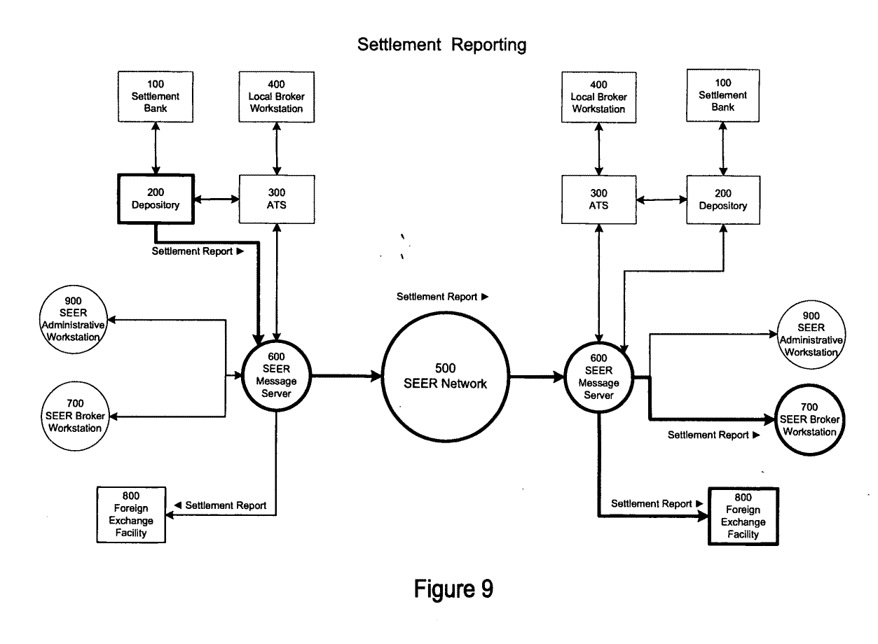

The system of FIG. 9 illustrates settlement information flow. The SEER Message Server receives Settlement Reports from the Depository for those brokers who have executed cross-border trades in that market. Each trade is listed along with volume, price and client account information. The report also includes the total amount that the broker is to pay or collect for that day's trades. The local message server routes these reports to the message servers in the foreign markets. These servers then distribute the reports to the relevant brokers and associated bank or foreign exchange facility. The monetary settlement obligation of the broker is discharged by the local bank or foreign exchange facility on Settlement Day, in the currency of execution, with the broker having previously settled with the facility. The Depository on receiving notification that money settlement has occurred concludes the securities transaction.

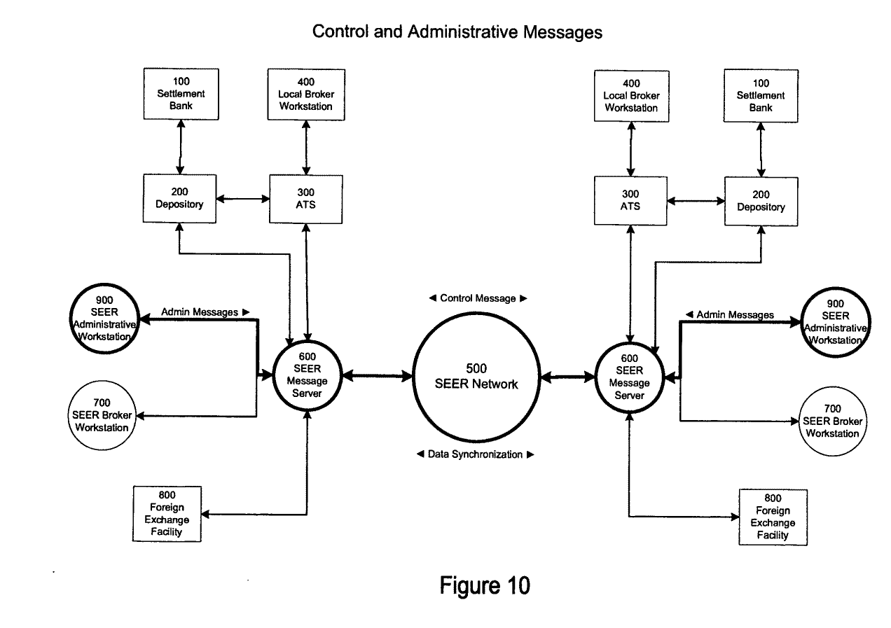

FIG. 10 is a flow diagram illustrating data entry and the routing of administrative messages and instructions between markets by the SEER Administrative Workstations via the SEER Network. This includes the introduction of securities eligible for cross-border trading; addition and deletion of brokerage firms and brokers authorized to trade on the system; information regarding brokerage firm settlement exposure; updates to settlement guarantees; opening of client accounts; changes in exchange trading hours and days, and other market announcements.

### OPERATION

### First Embodiment

To illustrate the preferred embodiment of my invention, we consider two clients, one in Jordan and one in Abu Dhabi.

Client A, in Jordan, submits a bid or offer for Arab Bank to his broker. The broker enters the order into Amman Stock Exchange's automated trading system. The system posts the order in its book and disseminates it via its market data broadcast. The SEER Message Server picks up that bid or offer and distributes it to all exchanges on the SEER Network.

The SEER server in each exchange on the SEER Network delivers that market information to all SEER Broker Workstations and broker systems for display.

The SEER Server in each exchange collects foreign exchange currency quotations from local foreign exchange banks or facilities.

The server then delivers that currency information to all SEER Broker workstations and broker systems.

The broker workstation applies the information to assess the value of the bids and offers.

Client B in Abu Dhabi sees the bid or the offer in both the executing currency and his local currency, and decides to trade against it. He gives an order to his broker who enters it into his SEER Broker Workstation. The workstation passes the order to the local SEER Message Server. The server recognizes the security as a Jordanian security and routes it to the server located at the Amman Stock Exchange (ASE). It then enters the order into the ASE's automated trading system. The order is then processed in accordance with ASE rules and procedures. On execution of the order, the ATS generates an execution report and transmits it to the originator of the order (in this illustration, the local SEER Message Server is the delivery address). The server then routes the trade report to the Abu Dhabi message server, which delivers the trade Confirmation to the originating broker.

The ASE reports all trades executed that day to the Jordan Securities Depository Centre (SDC), including cross-border trades. The SDC verifies each transaction and generates a Settlement Report for each broker that traded on the ASE on that day, including those brokers at foreign exchanges that executed orders on the ASE.

The local SEER Server then routes these reports to the relevant brokers in the receiving country via the SEER Network. The receiving message server delivers the reports.

The settlement process then begins when, in our illustration, the Abu Dhabi client pays his broker the value of the transaction in his local currency.

The Abu Dhabi broker then pays the local bank or foreign exchange facility the amount due on the transaction in his local currency. In reality, the broker pays or collects the net amount resulting from the transactions on that day.

The local bank or foreign exchange facility then pays or collects the amount due to/from the Abu Dhabi broker's account in the corresponding Settlement Bank.

The Settlement Bank, after verifying that all dues have been paid, transfers funds between the paying and collecting accounts, after which it advises the depository that money settlement has been completed.

Upon receipt of this advice, the depository effects settlement of the said securities and financial instruments.

### Broker Authorization

The process of broker authorization for trading privileges on SEERTrade® begins with an application to the broker's home exchange administrators, who grant permission. The administrators key-enter the broker's profile into the local SEER Administrative Workstation, which passes it to the local SEER Message Server. The server then distributes this information to each of the other servers on the network, which then registers the broker in the local rules database.

### Listing Securities

The process of listing a given security for cross-border trading begins when an issuing company requests that privilege. The details are then key-entered to the local SEER Message Server. The server distributes this information to each of the other servers on the network, which in turn lists the security in its local rules database.

### Client Account Opening

Opening a client account in a foreign market is usually done by the client's broker. The first step is to obtain Account Opening forms and related instructions from the market in which the client wishes to invest. The client completes the forms and provides necessary identification. The brokerage firm opening the account authenticates the client's ID and the forms as finalized. The documents are scanned and transmitted to the market in which the account is being opened. As an added precaution, a supervisor of the firm, other than the person submitting the account forms, approves the submission in a separate message. The receiving market approves the submission and sends the submitting market the Client ID number assigned by its system.)

In an alternative embodiment, the broker in a given country submits the Client Account Opening forms to the local market management. The exchange management scans the documents and transmits the scanned images to the market in which the account is being opened. As an added security precaution, a supervisor of the exchange (other than the person that submitted the account forms) approves the submission in a separate message.

### Advantages to Investors

The embodiment of my invention, diagrammed in FIG. 2, provides the following advantages over the existing cross-border trading and settlement process.

Gives investors access to previously unavailable foreign markets
Eliminates dual commissions
Trading enabled at real-time prices
Increases liquidity
More accurate price discovery with all orders commonly visualized
Eliminates arbitrage
Execution price known in local currency at time of trade
Provides a regional and international best bid/offer

### Advantages to Companies

Eliminates the need for Depository Receipts (GDRs or ADRs)
Eliminates the need for multiple listings and costs thereof.
Eliminates market fragmentation as all trading is done in the country of issue
Enables a broader shareholder base
One shareholder register in the country of issue
Boosts access to foreign capital
Enables more efficient Initial Public Offerings (IPOs)

### Advantages to Brokers

Wider pool of securities for investors
No need for membership in multiple exchanges
No contractual relationship required with other brokers
Lowers costs and provides direct access to foreign markets
Trading can take place on any exchange in the network from local offices
Settlement occurs in the home country

### Advantages to Exchanges and Depositories

No Global or regional hub—no central point of failure
No centralized computer system—each market retains its own systems
No need to modify computer systems
No centralized Clearing House—settlement is in the country of issue
No common trading or settlement platform required
Centralizes trading and settlement in the country of issue
No new exchanges required
No need for a regional specialty exchange
No need to harmonize rules, procedures, practices and conventions
No common currency required
Preserves and strengthens existing exchanges
National identity is maintained

### Advantages to Regulators

Improves access to market information
Improves market surveillance

### Advantages to Market and Host Economies

No broker or security selection issues with participation being self-determined
Expands the local market
Creates greater efficiency through lower cost and closer integration
Joins markets without requiring system, rules or procedure changes
Enables broad market expansion at minimal cost
Enables creation of regional indices
Provides an international gateway to the local market

### CONCLUSION, RAMIFICATIONS, AND SCOPE

The reader will see that according to the preferred embodiment of the invention, I have provided a unique system to enable the cross-border trading and settlement of securities worldwide, linking markets and exchanges through a specifically devised computer network. The preferred embodiment provides the advantages already specified, and remains unique, within the beneficial context of the prevailing rules, practices, procedures, and automated systems of markets worldwide.

While the above description contains many specificities, these should not be construed as limitations on the scope of the preferred embodiment, but rather as exemplifications of the preferred embodiments thereof.

Thus the scope of the invention should be determined by the appended claims and their legal equivalents.

### SEQUENCE LISTING

Not applicable

Glossary

| | |
|---|---|
| ADX | Abu Dhabi Stock Exchange |
| API | Application Programming Interface - a set of |
| | functions, procedures or classes that an operating |
| | system, library or service provides to support |
| | requests made by computer programs. Used by |
| | SEERTrade ® to enable access to |
| ASE | Amman Stock Exchange |
| ATS | Automated Trading System |
| CSD | Central Securities Depository - A depository |
| | is a central holding place, or repository, of |
| | financial securities. It transfers shares and |
| | bonds electronically, through a computer entry, |
| | and eliminates the need of investors to hold |
| | securities physically. |
| CASE | Cairo and Alexandria Stock Exchange, recently |
| | renamed the Egyptian Stock Exchange |
| Duplex | The method of operation of a communications |
| | circuit in which each end can simultaneously |
| | transmit and receive. |
| IP address | Internet Protocol address is a 32-bit (4 byte) binary |
| | number that uniquely identifies a host computer to |
| | other computers for the purpose of communications. |
| Mesh Network | A communications network having two or more |
| | paths to any node. |
| Middleware | Software that sits between two or more types of |
| | software and translates between them. Middleware |
| | is computer software that connects software |
| | components or applications. The software consists |
| | of a set of enabling services that allow multiple |
| | processes running on one or more machines to |
| | interact across a network. This technology evolved |
| | to provide for interoperability in support of the |
| | move to coherent distributed architectures, which |
| | are used most often to support and simplify complex, |
| | distributed applications. It includes web servers, |
| | application servers, and similar tools that support |
| | application development and delivery. Middleware |
| | is especially integral to modern information |
| | technology based on XML, SOAP, Web services, and |
| | service-oriented architecture. |
| Multicasting | The process of sending a message simultaneously to |
| | more than one destination on a network. |
| Omnibus | A single account for the commingled funds or |
| | positions of multiple parties. A clearing |
| | member will offer maintain an omnibus account |
| | at the clearing house for all of its clients. |
| OMS | Order Management System |
| Server IP | The Internet Protocol address of the server. |
| TCP | Transmission Control Protocol, a standard data |
| | transmission protocol that provides full |
| | duplex transmission |

### PROPRIETARY TERMS

The following terms used in this summary are to be considered proprietary and under intellectual property protection as my copyrights, trademarks and service marks.

### SEERTrade®

### SEER Broker Workstation

### SEER Administrative Workstation

### SEER Network

SEER Message Server

What is claimed is:

1. An on-line, interactive computer system linking securities and commodities markets within and across national boundaries, for the purpose of trading securities and commodities listed on each participating market within said linked network of markets (such that) each order meets, trades and settles in the home market of the traded security or commodity using said market's rules, procedures and prices, comprising:
a plurality of securities and commodities markets on which said securities and commodities are traded at their respective home markets via an automated trading system, and which said trades are settled via their respective home market electronic settlement system;
a communications network coupled to said plurality of securities and commodities markets automated trading systems and electronic settlement systems without necessitating provision of a hub or central point of control and adapted to receive and exchange securities transactions between said plurality of markets;
a plurality of market-based message/communications servers, coupled to said communications network and interfaced to said securities and commodities market automated trading and electronic settlement systems, local market foreign exchange facilities, local market user workstations, administrative workstations and adapted to interface each local market with each other participating market;
a plurality of user workstations coupled to said servers and interfaced to said linked securities and commodities markets adapted for viewing market information re securities available for trading in the other participating markets, entering trade and settlement transactions (but not limited to such transactions) for said securities and commodities in said markets, and in accordance with each such market's rules and procedures and prices;
a foreign exchange facility or facilities coupled to each said home market server and configured to provide real-time foreign exchange conversion rates for use in the submission of bids and the execution of trades of said securities or commodities in said linked markets.
an administrative workstation linked to said home market server and adapted to enable authorized home market personnel to enter administrative messages and other information pertaining to said securities and commodities markets;
a relational database maintained on the local market server, storing details for each participating market, including but not limited to: list of tradable securities by market, list of authorized brokerage firms and authorized brokers by market, orders entered by market, orders executed by market, real-time bids, offers and related market data;

2. the system of claim 1, wherein said system is a user workstation coupled to the server local market server, or a broker Order management System coupled to the server local market server or an exchange operated trade support system coupled to the server local market server;

3. The method of claim 1, wherein said foreign exchange facility acts as a data source for guaranteed foreign currency exchange rates for converting the traded security's or commodity's quoted price in that instrument's home market currency to the user's local currency;

4. The method of claim 3 wherein said data on currency exchange rates is collected from a foreign exchange facility and made available at order entry time, further comprising:
receiving from said foreign exchange facility currency conversion rates for each pair of currencies incorporated in the network;
disseminating said currency rates to the user workstations;
at order entry, sending foreign currency conversion instructions resulting from an order to buy or sell a foreign security
at trade execution time receiving sending said foreign exchange facility a statement of said currency exchange including the amount deliverable in each currency and the value date for settlement;

5. The method of claim 4, wherein said conversion of said currencies occurs on a settlement date for said purchase or sale;

6. The method of claim 5, further comprising:
on settlement day, buying broker delivers local currency to said foreign exchange facility for the purposes of settling trade;
on settlement day, said foreign exchange facility arranges payment to said market's settlement bank in that market's local currency;

7. The system of claim 1, further comprises the storing of said transactional data in a secure environment;

8. A method of trading securities and commodities listed on said plurality of linked markets using an on-line, interactive computer system of linked markets within and across national boundaries using each market's rules, procedures and computer systems, comprising the acts of:
collecting at the home market server for each security, real-time market data from said local market's automated trading system in each participating market;
routing said market data to the server at each participating market for dissemination to local market participants, to financial news media and other subscribers;
disseminating said data to all participating markets' servers, to the media, and to subscribers;
receiving said real-time market data in each said participating market, storing said data in a local relational database, and disseminating said data to local market user workstations, broker order management systems and to local exchange systems as required;
displaying said real-time market data on user workstations each with a graphical user interface adapted for maintaining market information of those markets that are linked to the user's home market and for entering bids and offers and other transactional data for said non-local securities or commodities;
calculating market indices and disseminating said data to local market user workstations, broker order management systems and to local exchange systems as required;
collecting real-time and static foreign exchange data, storing said data in said local relational database and disseminating said data to said user workstations, order management systems and exchange provided workstations;
collecting orders, cancellations and other market-related transactions from user workstations coupled to the server;
electronically transmitting the order to the server linked to the ATS of the home market of said security or commodity;
upon receipt of the order at the home market for said security, electronically entering the order in said market's automatic trading system utilizing said market's financial messaging protocol;
receiving from said market details regarding the disposition of said order including execution information, entry into said market's order book, or other action;
routing said information to the order originator;
upon receipt of said order from the market server associated with the order originator electronically entering said order into said security's or commodity's said automated trading system;
notifying the order originator of the disposition of said order;
displaying the execution information correlated with the displayed order information on said user workstation;
automatically correlating said execution information with said order information and electronically transmitting said information to the user workstation;
receiving settlement reports from each market's electronic settlement system and routing said reports and associated data and instructions to each trading counterparty;
providing via an administrative workstation operated by home market personnel information regarding market operation including but not limited to market status (Pre-open, Open, Pre-close, Close, Trading halts, suspensions, listed securities, authorized brokerage firms, authorized brokers, client identification registration and authorization forms, settlement dates and cut-off times;
